(19) United States
(12) Patent Application Publication
(10) Pub. No.: US 2007/0066825 A1
(43) Pub. Date: Mar. 22, 2007

(54) Chiral ligands and their transition metal complexes

(76) Inventors: Ulrich Scholz, Mulheim (DE); Bjorn Schlummer, Leverkusen (DE); Paul Knochel, Munich (DE); Tanasri Bunlaksananusorn, Munich (DE)

Correspondence Address: Lanxess Corporation;Patent Department, 111 Ridc Park West Drive, Pittsburgh, PA, 15275-1112, US

(21) Appl. No.: 10/554,577

(22) PCT Filed: May 15, 2004
(86) PCT No.: PCT/EP04/05251

§ 371 Date: Sep. 14, 2006

(30) Foreign Application Priority Data
May 22, 2003 (DE) 10323692.9

(51) Int. Cl. C07F 9/58; C07F 15/00

(52) U.S. Cl. 546/2; 546/22

(57) ABSTRACT

The present invention relates to chiral phosphorus compounds and their transition metal complexes, and also to the use of these transition metal complexes, especially in asymmetric syntheses.

The present invention relates to chiral nitrogen-phosphorus compounds and their transition metal complexes, and also to the use of these transition metal complexes, especially in asymmetric syntheses.

Enantiomerically enriched chiral compounds are valuable starting substances for preparing agrochemicals and pharmaceuticals. Asymmetric catalysis has gained great industrial significance for the synthesis of such enantiomerically enriched chiral compounds.

The multitude of publications in the field of asymmetric synthesis show clearly that transition metal complexes of nitrogen-phosphorus compounds are highly suitable as catalysts in asymmetric reactions, especially allylic substitutions, hydrogenations and Heck reactions (see also Malkov et al., Tetrahedron Letters, 2001, 42, 3045-3048; Pfaltz et al., Adv. Synth. Cat., 2003, 345, 33-44; Chelucci et al., Tetrahedron, 2001, 57, 9989-9996, Schleich, Helmchen, Eur. J. Org. Chem., 1999, 2525-2521).

A disadvantage of the compounds known to date is that the preparation proceeds in a complicated manner over several stages, the steric and electronic variation of the central ligand skeleton is difficult and there is only rarely applicability for a broad substrate spectrum in catalytic reactions.

There is therefore still the need to develop a ligand system whose steric and electronic properties are readily variable and whose transition metal complexes, as catalysts, especially in asymmetric synthesis, enable not only good enantioselectivity but also good conversion rates.

Nitrogen-phosphorus compounds of the formula (I) have now been found 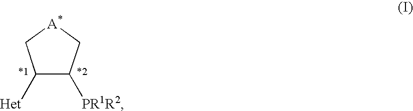
in which
*1, *2 each independently mark a stereogenic carbon atom which is in R or S configuration,
R¹ and R² are each independently an optionally substituted hydrocarbon radical having a total of 1 to 18 carbon atoms
Het is optionally substituted azoaryl and
A* is a carbodivalent, cyclic and optionally substituted radical which has a total of 5 to 18 carbon atoms and in itself, as a symmetry element, does not possess any mirror plane.

In the context of the invention, all radical definitions, parameters and illustrations above and listed below, mentioned in general or within areas of preference, may be combined with one another in any desired manner, i.e. also between the individual areas and areas of preference.

The term “carbodivalent, cyclic” means that the bond of the A* radical to the rest of the molecule of the formula (I) is via two carbon atoms and the A* radical has at least one cycle.

Alkyl, alkylene and alkoxy are each independently a straight-chain, cyclic, branched or unbranched alkyl, alkylene and alkoxy radical respectively. The same applies to the nonaromatic moiety of an arylalkyl radical.

C₁-C₄-Alkyl is, for example, methyl, ethyl, n-propyl, isopropyl, n-butyl, sec-butyl and tert-butyl; C₁-C₈-alkyl is additionally, for example, n-pentyl, 1-methylbutyl, 2-methylbutyl, neopentyl, cyclohexyl, cyclopentyl and n-hexyl; C₁-C₁₂-alkyl is further additionally, for example, adamantyl, the isomeric menthyls, n-nonyl, n-decyl and n-dodecyl; C₁-C₂₀-alkyl is still further additionally, for example, n-hexadecyl and n-octadecyl.

C₁-C₈-Alkoxy is, for example, methoxy, ethoxy, n-propoxy, isopropoxy, n-butoxy, sec-butoxy and tert-butoxy, n-pentoxy, neopentoxy, cyclohexoxy, cyclopentoxy, n-hexoxy and n-octoxy; C₁-C₁₂-alkoxy is further additionally, for example, adamantoxy, the isomeric menthoxy radicals, n-decoxy and n-dodecoxy.

C₂-C₂₀-Alkenyl is, for example, vinyl, 1-propenyl, isopropenyl, 1-butenyl, 1-hexenyl, 1-heptenyl, 1-octenyl or 2-octenyl.

Fluoroalkyl is in each case independently a straight-chain, cyclic, branched or unbranched alkyl radical which is monosubstituted, polysubstituted or persubstituted by fluorine atoms.

For example, C₁-C₂₀-fluoroalkyl is trifluoromethyl, 2,2,2-trifluoroethyl, pentafluoroethyl, nonafluorobutyl, perfluorooctyl, perfluorododecyl and perfluorohexadecyl.

Aryl represents a heteroaromatic radical having 5 to 18 skeleton carbon atoms of which no, one, two or three skeleton carbon atoms per cycle, but at least one skeleton carbon atom in the entire molecule, may be substituted by heteroatoms selected from the group of nitrogen, sulphur and oxygen, but preferably represents a carbocyclic aromatic radical having 6 to 18 skeleton carbon atoms.

Examples of carbocyclic aromatic radicals having 6 to 18 skeleton carbon atoms are phenyl, naphthyl, phenanthryl, anthracenyl or fluoroenyl; heteroaromatic radicals having 5 to 18 skeleton carbon atoms of which no, one, two or three skeleton carbon atoms per cycle, but at least one skeleton carbon atom in the entire molecule, may be substituted by heteroatoms selected from the group of nitrogen, sulphur and oxygen are, for example, pyridinyl, oxazolyl, benzofuranyl, dibenzofuranyl or quinolinyl.

Moreover, the carbocyclic aromatic radical or heteroaromatic radical may be substituted by up to five identical or different substituents per cycle which are each independently selected from the group of chlorine, fluorine, C₁-C₁₂-alkyl, C₄-C₁₀-aryl, C₅-C₁₁-arylalkyl, C₁-C₁₂-alkoxy, di(C₁-C₈-alkyl)amino, COO(C₁-C₈-alkyl), CON(C₁-C₈-alkyl)₂, COO(C₁-C₈-arylalkyl), COO(C₄-C₁₄-aryl), CO(C₁-C₈-alkyl), C₅-C₁₅-arylalkyl or tri(C₁-C₆-alkyl)siloxyl.

The same applies analogously to aryloxy radicals.

Azoaryl represents a heteroaromatic radical having 5 to 18 skeleton carbon atoms of which no, one, two or three skeleton carbon atoms per cycle, but at least one skeleton carbon atom in the entire molecule, may be substituted by heteroatoms, but at least one nitrogen atom has to be present, and any further heteroatoms are selected from the group of nitrogen, sulphur and oxygen. For further substituents, the same applies as stated above for aryl.

Arylalkyl is in each case independently a straight-chain, cyclic, branched or unbranched alkyl radical which may be monosubstituted, polysubstituted or persubstituted by aryl radicals as defined above.

C₅-C₁₄-Arylalkyl is, for example, benzyl, 1-phenylethyl, 1-phenylpropyl, 2-phenylpropyl and 1-naphthylmethyl and also, if appropriate, the isomeric or stereoisomeric forms.

Arylalkenyl is in each case independently a straight-chain, cyclic, branched or unbranched alkenyl radical which may be monosubstituted, polysubstituted or persubstituted by aryl radicals as defined above.

C₆-C₁₄-Arylalkenyl is, for example, 1-phenylvinyl or 2-phenylvinyl.

The preferred substitution patterns for compounds of the formula (I) are defined hereinbelow: The circumstance that A* is a carbodivalent and cyclic radical typically results in severe restriction of the conformational mobility of the ethylene bridge bearing the Het and PR¹R² radicals. The Het and PR¹R² radicals are preferably arranged trans to one another.

The circumstance that the carbon atoms denoted by 1* and 2* in formula (I) are stereogenic and the A* radical, in itself as a symmetry element, does not possess any mirror plane results in the compounds of the formula (I) occurring in the form of stereoisomers. The invention encompasses both the pure stereoisomers and any mixtures thereof.

Preference is given to stereoisomerically enriched compounds of the formula (I). In the context of the invention, stereoisomerically enriched means that one stereoisomer is present in a greater relative proportion than the particular other stereoisomer. The other stereoisomers may either be enantiomers or diastereomers.

The relative proportion of only one stereoisomer based on the sum of all stereoisomers is preferably at least 90%, more preferably at least 95% and most preferably at least 98.5%.

R¹ and R² are preferably each independently: C₁-C₂₀-alkyl, C₁-C₂₀-fluoroalkyl, C₂-C₂₀-alkenyl, C₄-C₂₄-aryl, C₅-C₂₅-arylalkyl or C₆-C₂₆-arylalkenyl, or together are a cyclic radical having a total of 4 to 20 carbon atoms.

R¹ and R² are more preferably each identically: C₃-C₁₂-alkyl, C₄-C₁₄-aryl, C₅-C₁₃-arylalkyl or, together, are C₄-C₅-alkylene.

R¹ and R² are most preferably each identically: isopropyl, tert-butyl, cyclohexyl, phenyl, 2-(C₁-C₈)-alkylphenyl such as o-tolyl, 3-(C₁-C₈)-alkylphenyl such as m-tolyl, 4-(C₁-C₈)-alkylphenyl such as p-tolyl, 2,6-di-(C₁-C₈)-alkylphenyl such as 2,6-dimethylphenyl, 2,4-di-(C₁-C₈)-alkylphenyl such as 2,4-dimethylphenyl, 3,5-di-(C₁-C₈)-alkylphenyl such as 3,5-dimethylphenyl, 3,4,5-tri-(C₁-C₈)-alkylphenyl such as mesityl and isityl, 2-(C₁-C₈)-alkoxyphenyl such as o-anisyl and o-phenethyl, 3-(C₁-C₈)-alkoxyphenyl such as m-anisyl and m-phenethyl, 4-(C₁-C₈)-alkoxyphenyl such as p-anisyl and p-phenethyl, 2,4-di-(C₁-C₈)-alkoxyphenyl such as 2,4-dimethoxyphenyl, 2,6-di-(C₁-C₈)-alkoxyphenyl such as 2,6-dimethoxyphenyl, 3,5-di-(C₁-C₈)-alkoxyphenyl such as 3,5-dimethoxyphenyl, 3,4,5-tri-(C₁-C₈)-alkoxyphenyl such as 3,4,5-trimethoxyphenyl, 3,5-dialkyl-4-(C₁-C₈)-alkoxyphenyl such as 3,5-dimethyl-4-anisyl, 3,5-(C₁-C₈)-dialkyl-4-di-(C₁-C₈)-alkylaminophenyl, 3,5-dimethyl-4-dimethylaminophenyl, 4-di-(C₁-C₈)-alkylaminophenyl such as 4-diethylaminophenyl and 4-dimethylaminophenyl, 3,5-bis-[(C₁-C₄)-fluoroalkyl]phenyl such as 3,5-bis-trifluoromethylphenyl, 2,4-bis-[(C₁-C₄)-fluoroalkyl]phenyl such as 2,4-bis-trifluoromethylphenyl, 4-[(C₁-C₄)-fluoroalkyl]phenyl such as 4-trifluoromethylphenyl, and phenyl, fluorenyl or naphthyl which are each mono-, di-, tri-, tetra- or pentasubstituted by fluorine and/or chlorine, such as 4-fluorophenyl and 4-chlorophenyl and also furanyl.

Azoaryl is preferably 2-pyridyl or 2-quinolyl, where the radicals mentioned may further be substituted by one, two or three radicals which are each independently selected from the group of chlorine, bromine, fluorine, C₁-C₁₂-alkyl, C₄-C₁₀-aryl, C₅-C₁₁-arylalkyl and C₁-C₁₂-alkoxy.

Most preferably, azoaryl is 2-pyridyl, 6-bromo-2-pyridyl, 6-phenyl-2-pyridyl and 2-quinolyl.

Particularly preferred compounds of the formula (I) are those of the formulae (Ia) and (Ib) 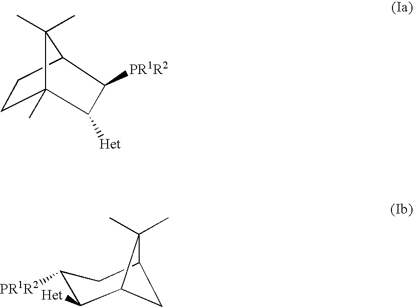
in which
R¹, R² and Het each have the definitions and areas of preference specified above.

Compounds of the formula (I) include:
2-[(1S,2R,3R,4S)-3-(diphenylphosphino)-1,7,7-trimethylbicyclo[2.2.1]hept-2-yl]pyridine,
2-[(1S,2R,3S,4S)-3-(diphenylphosphino)-1,7,7-trimethylbicyclo[2.2.1]hept-2-yl]-6-phenylpyridine,
2-[(1S,2R,3R,4S)-3-(dicyclohexylphosphino)-1,7,7-trimethylbicyclo[2.2.1]hept-2-yl]pyridine,
2-[(1S,2R,3S,4S)-3-(diphenylphosphino)-1,7,7-trimethylbicyclo[2.2.1]hept-2-yl]quinoline,
2-[(1S,2R,3S,5R)-3-(diphenylphosphino)-6,6-dimethylbicyclo[3.1.1]hept-2-yl]pyridine and
2-[(1S,2R,3S,5R)-3-(diphenylphosphino)-6,6-dimethylbicyclo[3.1.1]hept-2-yl]-6-phenylpyridine.

The compounds of the formula (I), or (Ia) and (Ib), may be prepared, for example, starting from compounds of the formula (II) according to the scheme below.

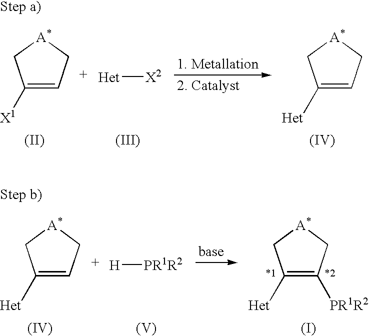

In the formulae (II), (III), (IV) and (V), 1*, 2*, R¹, R², Het and A* each independently have the definitions and areas of preference specified above.

X¹ and X² are each independently chlorine, bromine, iodine or a sulphonate, preferably bromine, iodine or a C₁-C₄-perfluoroalkylsulphonate.

The metallation can, for example, be effected in such a way that the compounds of the formula (III) are converted in a manner known per se to an analogous organozinc or organomagnesium compound, and these are then reacted with compounds of the formula (II) in the presence of catalyst to give compounds of the formula (IV). The catalysts used in step a) may, for example, be palladium complexes or nickel complexes.

The compounds of the formula (IV), as valuable intermediates for compounds of the formula (I), are likewise encompassed by the invention. All areas and areas of preference mentioned for Het and A* apply analogously.

Preferred compounds of the formula (IV) are those of the formulae (IVa) and (IVb): 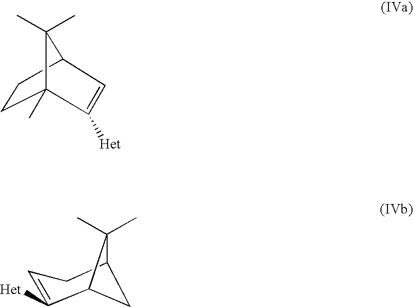
in which
Het has the definition and its areas of preference specified under the formula (I).

Individual compounds include:
2-[(1R,4R)-1,7,7-trimethylbicyclo[2.2.1]hept-2-en-2-yl]pyridine,
2-bromo-6-[(1R,4R)-1,7,7-trimethylbicyclo[2.2.1]hept-2-en-2-yl]pyridine,
2-[(1R,4R)-1,7,7-trimethylbicyclo[2.2.1]hept-2-en-2-yl]quinoline,
2-[(1R,5S)-6,6-dimethylbicyclo[3.1.1]hept-2-en-2-yl]pyridine,
2-bromo-6-[(1R,5S)-6,6-dimethylbicyclo[3.1.1]hept-2-en-2-yl]pyridine,
2-phenyl-6-[(1R,4R)-1,7,7-trimethylbicyclo[2.2.1]hept-2-en-2-yl]pyridine and
2-[(1R,5S)-6,6-dimethylbicyclo[3.1.1]hept-2-en-2-yl]-6-phenylpyridine.

Step b) can be effected in such a way that compounds of the formula (V) are converted in the presence of a base which can at least partly deprotonate the compounds of the formula (V) in the presence of a solvent to give compounds of the formula (I).

Preferred bases are alkoxides; preferred solvents are sulphoxides, for example dimethyl sulphoxide, sulphones, for example tetramethylenesulphone, or secondary carboxamides such as dimethylformamide or N-methylpyrrolidone.

A particularly advantageous method is that described by Knochel et al. in Tetrahedron Letters, 2002, 43, 5817-5819 using potassium tert-butoxide as the base and dimethyl sulphoxide as the solvent.

Alternatively to step b), it is possible according to the scheme below,

in a step c),

to convert the compounds of the formula (IV) by reaction with compounds of the formula (VI) to compounds of the formula (VII) and,

in a step d),

to reduce the compounds of the formula (VII) to compounds of the formula (I).

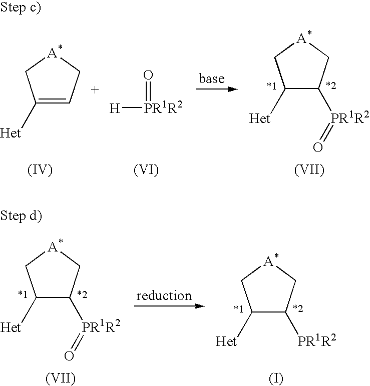

Step c) can be carried out entirely analogously to step b), step d) in a manner known per se, for example by reduction with silanes, especially trichlorosilane, in the presence of a base, especially triethylamine.

The process which comprises steps c) and d) may be advantageous especially in the case of use of electron-rich phosphines of the formula (III).

The compounds of the formula (VII), as valuable intermediates for compounds of the formula (I), are likewise encompassed by the invention. All areas and areas of preference mentioned apply analogously to Het and A*.

Preferred compounds of the formula (VII) are those of the formulae (VIIa) and (VIIb): 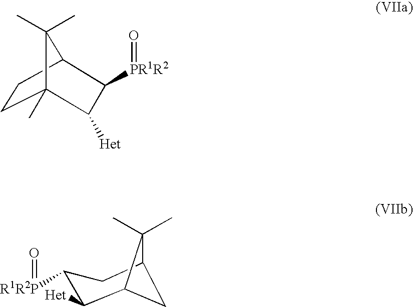
in which
R¹, R² and Het each have the definitions and areas of preference specified above.

Individual compounds of the formulae (VIIa) and (VIIb) include:
2-[(1S,2S,3R,4S)-3-(diphenylphosphoryl)-1,7,7-trimethylbicyclo[2.2.1]hept-2-yl]pyridine,
2-[(1S,2R,3S,4S)-3-(diphenylphosphoryl)-1,7,7-trimethylbicyclo[2.2.1]hept-2-yl]-6-phenylpyridine,
2-[(1S,2S,3R,4S)-3-(dicyclohexylphosphoryl)-1,7,7-trimethylbicyclo[2.2.1]hept-2-yl]pyridine,
2-[(1S,2S,3R,4S)-3-(diphenylphosphoryl)-1,7,7-trimethylbicyclo[2.2.1]hept-2-yl]quinoline,
2-[(1S,2R,3S,5R)-3-(diphenylphosphoryl)-6,6-dimethylbicyclo[3.1.1]hept-2-yl]pyridine and
2-[(1S,2R,3S,5R)-3-(diphenylphosphoryl)-6,6-dimethylbicyclo[3.1.1]hept-2-yl]-6-phenylpyridine.

The invention further encompasses transition metal complexes which comprise the inventive compounds of the formula (I). Preference is given to transition metal complexes which comprise stereoisomerically enriched compounds of the formula (I).

Transition metal complexes are preferably complexes of ruthenium, osmium, cobalt, rhodium, iridium, nickel, palladium, platinum and copper, more preferably complexes of ruthenium, rhodium, iridium, nickel and palladium, and most preferably complexes of palladium and iridium.

The inventive transition metal complexes are suitable in particular as catalysts. The invention therefore also encompasses catalysts which comprise the inventive transition metal complexes.

The catalysts used may, for example, either be isolated transition metal complexes or those transition metal complexes which are obtainable by reacting transition metal compounds with compounds of the formula (I).

Isolated transition metal complexes which comprise the compounds of the formula (I) are preferably those in which the ratio of transition metal to compounds of the formula (I) is 1:1.

Preference is given to the inventive compounds of the formula (VIII)
[(I)L¹₂M]An (VIII)
in which (I) represents compounds of the formula (I) with the definition and its areas of preference specified there and
M is rhodium or iridium and
L¹ in each case is a C₂-C₁₂-alkene, for example ethylene or cyclooctene, or a nitrile, for example acetonitrile, benzonitrile or benzyl nitrile, or
L¹₂ together is a (C₄-C₁₂)-diene, for example bicyclo[2.1.1]hepta-2,5-diene (norbornadiene) or 1,5-cyclooctadiene and
An is a noncoordinating or weakly coordinating anion, for example methanesulphonate, trifluoromethanesulphonate, tetrafluorooborate, hexafluorophosphate, perchlorate, hexafluoroantimonate, tetra(bis-3,5-trifluoromethylphenyl)borate or tetraphenylborate.

However, preferred transition metal complexes are those which are obtainable by reacting transition metal compounds with compounds of the formula (I).

Suitable transition metal compounds are, for example, those of the formula
M(An¹)_{q} (IXa)
in which
M is rhodium, iridium, ruthenium, nickel, palladium, platinum or copper and
An¹ is chloride, bromide, acetate, nitrate, methanesulphonate, trifluoromethanesulphonate or acetylacetonate and
q is 3 for rhodium, iridium and ruthenium, is 2 for nickel, palladium and platinum, and is 1 for copper,
   or transition metal compounds of the general formula (IXb)
   M(An²)_{q}L¹₂ (IXb)
   in which
M is rhodium, iridium, ruthenium, nickel, palladium, platinum or copper and
An² is chloride, bromide, acetate, methanesulphonate or trifluoromethanesulphonate, tetrafluoroborate or hexafluorophosphate, perchlorate, hexafluoroantimonate, tetra(bis-3,5-trifluoromethylphenyl)borate or tetraphenylborate and
q is 3 for rhodium and iridium, is 2 for ruthenium, nickel, palladium and platinum, and is I for copper,
L¹ in each case is a C₂-C₁₂-alkene, for example ethylene or cyclooctene, or a nitrile, for example acetonitrile, benzonitrile or benzyl nitrile, or
L¹₂ together is a (C₄-C₁₂)-diene, for example bicyclo[2.1.1]hepta-2,5-diene (norbornadiene) or 1,5-cyclooctadiene
   or transition metal compounds of the formula (IXc)
   [ML²An¹_{2]2} (IXc)
   in which
M is ruthenium and
L² represents aryl radicals, for example cymene, mesityl, phenyl or cyclooctadiene, norbornadiene or methylallyl
   or transition metal compounds of the formula (IXd)
   [M(L³)₂]An⁴ (IXd)
   in which
M is iridium or rhodium and
L³ is (C₄-C₁₂)-diene, for example bicyclo[2.1.1]hepta-2,5-diene (norbornadiene) or 1,5-cyclooctadiene and
An⁴ is a noncoordinating or weakly coordinating anion, for example methanesulphonate, trifluoromethanesulphonate, tetrafluoroborate, hexafluorophosphate, perchlorate, hexafluoroantimonate, tetra(bis-3,5-trifluoromethylphenyl)borate or tetraphenylborate.

Additionally suitable as transition metal compounds are, for example, Ni(1,5-cyclooctadiene)₂, Pd₂(dibenzylideneacetone)₃, Pd[PPh₃]₄, cyclopentadienyl₂Ru, Rh(acac)(CO)₂, Ir(pyridine)₂(1,5-cyclooctadiene), Cu(phenyl)Br, Cu(phenyl)Cl, Cu(phenyl)I, Cu(PPh₃)₂Br, [Cu(CH₃CN)₄]BF₄ and [Cu(CH₃CN)₄]PF₆, or polynuclear bridged complexes, for example [Rh(1,5-cyclooctadiene)Cl]₂, [Rh(1,5-cyclooctadiene)Br]₂, [Rh(ethene)₂Cl]₂, [Rh(cyclooctene)₂Cl]₂.

The transition metal compounds used are preferably:

[Rh(cod)Cl]₂, [Rh(cod)Br]₂, [Rh(cod)₂]ClO₄, [Rh(cod)₂]BF₄, [Rh(cod)₂]PF₄, [Rh(cod)₂]ClO₆, [Rh(cod)₂]OTf, [Rh(cod)₂]BARF (Ar=3,5-bistrifluoromethylphenyl), [Rh(cod)₂]SbF₆, RuCl₂(cod), [(cymene)RuCl₂]₂, [(benzene)RuCl₂]₂, [(mesityl)RuCl₂]₂, [(cymene)RuBr₂]₂, [(cymene)RuI₂]₂, [(cymene)Ru(BF₄)₂]₂, [(cymene)Ru(PF₆)₂]₂, [(cymene)Ru(BARF)₂]₂ (Ar=3,5-bistrifluoromethylphenyl), [(cymene)Ru(SbF₆)₂]₂, [Ir(cod)Cl]₂, [Ir(cod)₂]PF₆, [Ir(cod)₂]ClO₄, [Ir(cod)₂]SbF₆, [Ir(cod)₂]BF₄, [Ir(cod)₂]OTf, [Ir(cod)₂]BARF (Ar=3,5-bistrifluoromethylphenyl), RuCl₃, NiCl₃, RhCl₃, PdCl₂, PdBr₂, Pd(OAc)₂, Pd₂(dibenzylideneacetone)₃, Pd(acetylacetonate)₂, CuOTf, CuI, CuCl, Cu(OTf)₂, CuBr, CuI, CuBr₂, CuCl₂, CuI₂, [Rh(nbd)Cl]₂, [Rh(nbd)Br]₂, [Rh(nbd)₂]ClO₄, [Rh(nbd)₂]BF₄, [Rh(nbd)₂]PF₆, [Rh(nbd)₂]OTf, [Rh(nbd)₂]BARF (Ar=3,5-bistrifluoromethylphenyl), [Rh(nbd)₂]SbF₆, RuCl₂(nbd), [Ir(nbd)₂]PF₆, [Ir(nbd)₂]ClO₄, [Ir(nbd)₂]SbF₆, [Ir(nbd)₂]BF₄, [Ir(nbd)₂]OTf, [Ir(nbd)₂]BARF (Ar=3,5-bistrifluoromethylphenyl), Ir(pyridine)₂(nbd), [Ru(DMSO)₄Cl₂], [Ru(CH₃CN)₄Cl₂], [Ru(PhCN)₄C₂], [Ru(cod)Cl₂]ₙ, [Ru(cod)₄(methallyl)₂], [Ru(acetylacetonate)₃].

Even more preferred are [Ir(cod)Cl]₂, [Ir(cod)₂]PF₆, [Ir(cod)₂]ClO₄, [Ir(cod)₂]SbF₆, [Ir(cod)₂]BF₄, [Ir(cod)₂]OTf, [Ir(cod)₂]BARF (BARF=3,5-bistrifluoromethylphenyl).

The amount of the transition metal compounds used may, based on the content of metal, for example, be 25 to 200 mol % based on the compound of the formula (I) used, preferably 50 to 150 mol %, even more preferably 75 to 125 mol % and more preferably still 100 to 115 mol %.

The catalysts which comprise the inventive transition metal complexes are suitable in particular for 1,4 additions, allylic substitutions, hydroborations, hydroformylations, hydrocyanations, Heck reactions and hydrogenations.

When the catalysts comprise transition metal complexes which comprise stereoisomerically enriched compounds of the formula (I), the catalysts are suitable in particular for the asymmetric performance of the aforementioned reactions. Preference is given in particular to asymmetric hydroborations, asymmetric hydrogenations and asymmetric allylic substitutions.

Preferred asymmetric hydrogenations are, for example, hydrogenations of prochiral C═C bonds, for example prochiral enamines, olefins, enol ethers, C═O bonds, for example prochiral ketones, and C═N bonds, for example prochiral imines. Particularly preferred asymmetric hydrogenations are hydrogenations of prochiral C═C bonds, for example prochiral enamines, olefins, and C═N bonds, for example prochiral imines.

The invention therefore also encompasses a process for preparing stereoisomerically enriched, preferably enantiomerically enriched, compounds, which is characterized in that the stereoisomerically enriched, preferably enantiomerically enriched, compounds are obtained either by catalytic hydrogenation of olefins, enamines, enamides, imines or ketones, or by hydroboration of alkenes and, if appropriate, subsequent oxidation, or by allylic substitution, and the catalysts used are those which comprise transition metal complexes of stereoisomerically enriched compounds of the formula (I) with the definition specified there.

The amount of the transition metal compound used or of the transition metal complex used may, based on the metal content, for example, be 0.001 to 5 mol % based on the substrate used, preferably 0.001 to 0.5 mol %, most preferably 0.001 to 0.1 mol %.

In a preferred embodiment, asymmetric hydrogenations, asymmetric hydroborations may be carried out, for example, in such a way that the catalyst is obtained from a transition metal compound and a stereoisomerically enriched compound of the formula (I), if appropriate in a suitable solvent, the substrate is added and the reaction mixture is placed under hydrogen pressure at reaction temperature or a suitable borane is added.

In a preferred embodiment, asymmetric allylic substitutions can be carried out, for example, in such a way that the catalyst is obtained from a transition metal compound and a stereoisomerically enriched compound of the formula (I), if appropriate in a suitable solvent, and the substrate and the nucleophile are added.

For hydrogenations and hydroborations, preference is given to using catalysts which comprise iridium complexes of compounds of the formula (I), and, for allylic substitutions, preference is given to using catalysts which comprise palladium complexes of compounds of the formula (I).

The areas of preference described above for the transition metal compounds or transition metal complexes which can be used apply here analogously.

The inventive catalysts are suitable in particular in a process for preparing stereoisomerically enriched, preferably enantiomerically enriched, active ingredients of medicaments and agrochemicals, or intermediates of these two classes.

The advantage of the present invention is that the ligands can be prepared in an efficient manner and their electronic and steric properties are variable within a wide range starting from readily available reactants. Moreover, the inventive ligands and their transition metal complexes, especially in asymmetric hydrogenations, hydroborations and allylic substitutions, exhibit good enantioselectivities and conversion rates.

### EXAMPLES

### Example 1

### Preparation of (1R,4R)-1,7,7-trimethylbicyclo[2.2.1]hept-2-en-2-yl trifluoromethanesulphonate

A solution of (1R,4R)-1,7,7-trimethylbicyclo[2.2.1]heptan-2-one {(D)-camphor} (10 mmol, 1.52 g) in THF (10 ml) was added at −78° C. to a solution of lithium diisopropylamide (LDA, 10 mmol) in THF (25 ml) and stirred for one hour. Subsequently, a solution of N-phenyltrifluoromethanesulphonimide (10.7 mmol, 3.82 g) in THF (15 ml) was added and the resulting reaction mixture was stirred at 0° C. for 14 hours. First 30 ml of saturated ammonium chloride solution and then diethyl ether for extraction were then added to this reaction mixture. The organic phase was washed with water and sodium chloride solution, and dried over MgSO₄. The residue was purified chromatographically by means of silica gel with pentane as the eluent and gave rise to the desired product (2.70 g, 90% of theory) in the form of a colourless liquid.

[α]²³_{D}=+8.63 (c 1.07, CHCl₃)

¹³C NMR (75 MHz, CDCl₃): δ 155.6, 118.9 (q, J=318 Hz), 57.3, 54.2, 50.5, 31.2, 25.7, 20.0, 19.3, 9.8 ppm.

MS (EI, 70 ev): 284 (M⁺, 22), 151(20), 123 (100), 95 (38), 81 (31), 55 (24).

### Example 2

### Preparation of (1R,5S)-6,6-dimethylbicyclo[3.1.1]hept-2-en-2-yl trifluoromethanesulphonate

Analogously to Example 1, the aforementioned product was obtained starting from (1R,5S)-6,6-dimethylbicyclo[3.1.1]heptan-2-one in a yield of 92% of theory.

[α]²⁶_{D}=−23.5 (c 0.545, CHCl₃).

¹³C NMR (75 MHz, CDCl₃): δ 155.4, 118.9 (q, J=315 Hz), 111.8, 46.7, 40.5, 40.1, 32.1, 28.6, 25.9, 21.2 ppm.

### Examples 3 to 9

### Preparation of Azoaryl Compounds of the Formulae (IVa) and (IVb)

### Example 3

### Preparation of 2-[(1R,4R)-1,7,7-trimethylbicyclo[2.2.1]hept-2-en-2-yl]pyridine

A solution of 2-bromopyridine (20 mmol, 3.16 g) in THF (20 ml) was added dropwise at −78° C. to a solution of n-BuLi (1.5 M in hexane, 20 mmol, 14 ml). The reaction mixture was stirred at −78° C. for 30 min and subsequently admixed dropwise with a solution of ZnBr₂ (1.7 M in THF, 21 mmol, 13 ml). After a further 15 min at −78° C., the solution was allowed to warm and, after 30 min, admixed with the alkenyl triflate from Example 1 (10 mmol, 2.84 g), Pd(dba)₂ (2 mol %, 0.2 mmol, 0.12 g) and diphenylphosphinoferrocene (dppf) (2 mol %, 0.2 mmol, 0.11 g) in THE (15 ml). The resulting mixture was subsequently heated under reflux for 15 hours. The THF was removed under reduced pressure and the residue diluted with diethyl ether. After washing with water and sodium chloride solution, the organic phase was dried over MgSO₄ and concentrated under reduced pressure. The oily residue was purified chromatographically by means of silica gel with diethyl ether as the eluent and gave rise to the desired product (1.66 g, 78% of theory).

[α]²⁷_{D}=−176.4 (c 1.825, CHCl₃).

¹³C NMR (75 MHz, CDCl₃): δ 157.8, 149.8, 149.4, 136.1, 135.9, 121.5, 121.3, 57.3, 55.3, 52.2, 32.1, 26.0, 20.1, 20.0, 14.5, 12.8 ppm.

### Example 4

### Preparation of 2-bromo-6-[(1R,4R)-1,7,7-trimethylbicyclo[2.2.1]hept-2-en-2-yl]pyridine

Analogously to Example 3, the aforementioned product was obtained starting from 2,6-dibromopyridine in a yield of 70% of theory.

¹³C NMR (75 MHz, CDCl₃): δ 158.6, 148.3, 141.6, 138.3, 137.7, 125.2, 119.7, 57.3, 55.2, 52.2, 31.9, 26.0, 20.0, 19.9, 12.7 ppm.

### Example 5

### Preparation of 2-[(1R,4R)-1,7,7-trimethylbicyclo[2.2.1]hept-2-en-2-yl]quinoline

Analogously to Example 3, the aforementioned product was obtained starting from 2-bromoquinoline in a yield of 65% of theory.

[α]²³_{D}=−181.3 (c 0.45, CHCl₃).

Mp: 96-98° C.

¹³C NMR (75 MHz, CDCl₃): δ 157.5, 150.1, 148.3, 137.8, 135.6, 130.0, 129.4, 127.6, 127.0, 125.9, 120.2, 57.1, 55.7, 52.5, 32.1, 26.2, 20.2, 19.9, 13.1 ppm.

MS (EI, 70 ev): 263 (M⁺, 70), 248 (100), 220 (62).

### Example 6

### Preparation of 2-[(1R,5S)-6,6-dimethylbicyclo[3.1.1]hept-2-en-2-yl]pyridine

Analogously to Example 3, the aforementioned product was obtained starting from 2-bromopyridine and the vinyl triflate from Example 2 in a yield of 85% of theory.

[α]²³_{D}=+27 (c 0.725, CHCl₃).

¹³C NMR (75 MHz, CDCl₃): δ 158.2, 149.4, 147.8, 136.4, 124.5, 121.6, 119.3, 43.2, 41.1, 38.2, 32.4, 31.9, 26.6, 21.3 ppm.

MS (EI, 70 ev): 198 (M⁺, 47), 184 (100), 156 (14).

### Example 7

### Preparation of 2-bromo-6-[(1R,5S)-6,6-dimethylbicyclo [3.1.1]hept-2-en-2-yl] pyridine

Analogously to Example 3, the aforementioned product was obtained starting from 2,6-dibromopyridine and the vinyl triflate from Example 2 in a yield of 70% of theory.

¹³C NMR (75 MHz, CDCl₃): δ 159.2, 146.3, 142.1, 138.8, 126.5, 125.7, 117.6, 42.9, 40.9, 38.3, 32.5, 31.9, 26.6, 21.4 ppm.

MS (EI, 70 ev): 278 (M⁺+1, 70), 236 (100), 154 (46).

### Example 8

### Preparation of 2-phenyl-6-[(1R,4R)-1,7,7-trimethylbicyclo[2.2.1]hept-2-en-2-yl]pyridine

A solution of the compound from Example 4 (0.50 mmol, 142 mg) and Pd(PPh₃)₄ (0.02 mmol, 23 mg, 4 mol %) in toluene (2 ml) was admixed with a solution of Na₂CO₃ (1 mmol, 106 mg) in H₂O (1 ml) and subsequently admixed with a solution of PhB(OH)₂ (0.53 mmol, 64 mg) in MeOH (1 ml). The mixture was stirred at 85° C. for 16 hours. After cooling, saturated aqueous ammonia solution (0.25 ml) and a saturated solution of Na₂CO₃ (2.5 ml) were added and the mixture was extracted with CH₂Cl₂. The combined organic phases were washed with water and sodium chloride solution, dried over MgSO₄ and concentrated under reduced pressure. The residue was purified chromatographically by means of silica gel with 2% diethyl ether in pentane as the eluent and gave rise to the desired product (131 mg, 91% of theory).

[α]²¹_{D}=+166.5 (c 0.585, CHCl₃).

¹³C NMR (75 MHz, CDCl₃): δ 156.3, 154.7, 148.6, 138.8, 135.5, 127.6, 127.5, 125.8, 118.3, 116.1, 55.7, 54.1, 50.9, 30.7, 24.8, 18.7, 18.5, 11.7 ppm.

### Example 9

### Preparation of 2-[(1R,5S)-6,6-dimethylbicyclo[3.1.1]hept-2-en-2-yl]-6-phenylpyridine

Analogously to Example 8, the aforementioned product was obtained starting from the compound from Example 7 in a yield of 95% of theory.

[α]²⁵_{D}=−13.2 (c 0.56, CHCl₃).

¹³C NMR (75 MHz, CDCl₃): δ 157.5, 156.4, 147.9, 140.2, 137.1, 129.0, 128.9, 127.3, 124.4, 118.1, 117.3, 43.0, 41.1, 38.3, 32.5, 31.9, 26.8, 21.4 ppm.

MS (EI, 70 ev): 275 (M⁺, 100), 260 (78), 232 (85).

### Examples 10 to 15

### Preparation of Compounds of the Formulae (VIIa) and (VIIb)

### Example 10

### Preparation of 2-[(1S,2S,3R,4S)-3-(diphenylphosphoryl)-1,7,7-trimethylbicyclo[2.2.1]hept-2-yl]pyridine

Diphenylphosphine oxide (1 mmol, 202 mg) in 2 ml of DMSO and the compound from Example 3 (1 mmol, 213 mg) were added successively under argon to a solution of potassium tert-butoxide (0.20 mmol, 23 mg) in 1 ml of DMSO. The reaction mixture was stirred at 60° C. for 15 hours. After cooling to room temperature, water and CH₂Cl₂ were added, and the combined organic phases were washed with water and sodium chloride solution, dried over MgSO₄ and concentrated under reduced pressure. The residue was purified chromatographically by means of silica gel with 10% diethyl ether in CH₂Cl₂ as the eluent and gave rise to the desired product (361 mg, 87% of theory).

[α]²³_{D}=+78.9 (c 0.56, CHCl₃).

Mp: 132-139° C.

¹³C NMR (75 MHz, CDCl₃): δ 159.7, 134.7 (d, J=94.0 Hz), 133.4 (d, J=94.0 Hz), 131.6-131.3 (m), 130.7 (d, J=2.7 Hz), 128.9 (d, J=11.0 Hz), 127.7 (d, J=11.0 Hz), 125.6, 121.4, 53.3 (d, J=2.9 Hz), 52.2 (d, J=5.1 Hz), 51.0, 48.1, 45.2 (d, J=70.4 Hz), 32.3 (d, J=13.7 Hz), 28.2, 21.2, 20.2, 14.5 ppm.

³¹P NMR (81 MHz, CDCl₃): δ 32.8 ppm.

MS (EI, 70 ev): 415 (M⁺, 6), 332 (30), 214 (100).

### Example 11

### Preparation of 2-[(1S,2R,3S,4S)-3-(diphenylphosphoryl)-1,7,7-trimethylbicyclo[2.2.1]hept-2-yl]-6-phenylpyridine

Analogously to Example 10, the aforementioned product was obtained starting from the compound from Example 8 with diphenylphosphine oxide in a yield of 72% of theory.

[α]²²_{D}=−68.9 (c 0.505, CHCl₃).

Mp: 69-72° C.

¹³C NMR (75 MHz, CDCl₃): δ 159.2, 155.2, 140.0, 136.4, 135.5, 134.2, 133.8, 132.6, 131.6-131.4 (m), 130.7 (d, J=2.3 Hz), 129.1, 128.8 (d, J=11.0 Hz), 127.6 (d, J=11.0 Hz), 126.9, 124.0, 117.8, 53.6 (d, J=2.9 Hz), 52.1 (d, J=5.2 Hz), 51.1, 48.1, 45.9, 45.0, 32.6 (d, J=13.7 Hz), 28.4, 21.1, 20.2, 14.6 ppm.

³¹P NMR (81 MHz, CDCl₃): δ 32.6 ppm.

MS (EI, 70 ev): 477 (M⁺, 7), 276 (100).

### Example 12

### Preparation of 2-[(1S,2S,3R,4S)-3-(dicyclohexylphosphoryl)-1,7,7-trimethylbicyclo[2.2.1]hept-2-yl]pyridine

Analogously to Example 10, the aforementioned product was obtained starting from the compound from Example 8 with dicyclohexylphosphine oxide in a yield of 55% of theory.

[α]²⁷_{D}=+14.7 (c 0.475, CHCl₃).

Mp: 128-132° C.

¹³C NMR (75 MHz, CDCl₃): δ 160.3, 148.9, 135.9, 126.1, 121.8, 53.3 (d, J=3.9 Hz), 51.7 (d, J=5.0 Hz), 50.6, 48.3 (d, J=2.1 Hz), 41.5-38.2 (m), 32.2 (d, J=11.8 Hz), 28.2-26.4 (m), 21.4, 20.1, 14.6 ppm.

³¹P NMR (81 MHz, CDCl₃): δ 50.8 ppm.

MS (EI, 70 ev): 427 (M⁺, 2.5), 344 (17), 214 (100).

### Example 13

### Preparation of 2-[(1S,2S,3R,4S)-3-(diphenylphosphoryl)-1,7,7-trimethylbicyclo[2.2.1]hept-2-yl]quinoline

Analogously to Example 10, the aforementioned product was obtained starting from the compound from Example 5 with diphenylphosphine oxide in a yield of 93% of theory.

[α]²⁸_{D}=+83.4 (c 0.525, CHCl₃).

Mp: 70-78° C.

¹³C NMR (75 MHz, CDCl₃): δ 160.1, 147.5, 135.1, 133.8, 132.5, 131.6-131.4 (m), 130.4 (d, J=2.7 Hz), 129.6-128.8 (m), 127.6-127.2 (m), 125.9, 123.9, 54.2 (d, J=2.4 Hz), 52.7 (d, J=4.6 Hz), 51.3, 48.0, 45.0 (d, J=80.0 Hz), 32.4 (d, J=14.0 Hz), 28.3, 21.2, 20.2, 14.9 ppm.

³¹P NMR (81 MHz, CDCl₃): δ 32.9 ppm.

MS (EI, 70 ev): 465 (M⁺, 3), 382 (7), 264 (100).

### Example 14

### Preparation of 2-[(1S,2R,3S,5R)-3-(diphenylphosphoryl)-6,6-dimethylbicyclo [3.1.1]hept-2-yl]pyridin

Analogously to Example 10, the aforementioned product was obtained starting from the compound from Example 6 with diphenylphosphine oxide in a yield of 86% of theory.

[α]²⁶_{D}=−24 (c 0.56, CHCl₃).

Mp: 57-63° C.

¹³C NMR (75 MHz, CDCl₃): δ 162.6 (d, J=2.7 Hz), 147.24, 135.9, 134.3, 133.1 (d, J=14 Hz), 131.8, 131.6 (m), 131.0 (d, J=2.7 Hz), 128.9 (d, J=11.0 Hz), 127.6 (d, J=11.0 Hz), 123.9, 121.0, 48.3 (d, J=5.6 Hz), 46.6, 40.7 (d, J=3.8 Hz), 39.1, 30.9, 27.9, 26.5 (d, J=2.1 Hz), 25.6, 24.7, 22.7 ppm.

³¹P NMR (81 MHz, CDCl₃): δ 38.4 ppm.

MS (EI, 70 ev): 401 (M⁺, 13), 200 (100).

### Example 15

### Preparation of 2-[(1S,2R,3S,5R)-3-(diphenylphosphoryl)-6,6-dimethylbicyclo [3.1.1]hept-2-yl]-6-phenylpyridine

Analogously to Example 10, the aforementioned product was obtained starting from the compound from Example 9 with diphenylphosphine oxide in a yield of 78% of theory.

[α]²⁹_{D}=+59.2 (c 0.76, CHCl₃).

Mp: 67-73° C.

¹³C NMR (75 MHz, CDCl₃): δ 162.6 (d, J=2.3 Hz), 154.4, 140.2, 136.9, 134.4, 133.1 (d, J=3.2 Hz), 131.8-131.5 (m), 130.9 (d, J=2.7 Hz), 129.1 (d, J=3.2 Hz), 128.9, 127.5 (d, J=11.3 Hz), 126.9, 122.4, 117.4, 48.3 (d, J=5.8 Hz), 46.9, 40.9 (d, J=4.1 Hz), 39.3, 31.4, 28.0, 26.6, 25.9, 24.9, 23.0 ppm.

³¹P NMR (81 MHz, CDCl₃): δ 37.9 ppm.

MS (EI, 70 ev): 477 (M⁺, 7), 276 (100).

### Examples 16-21

### Preparation of Compounds of the Formulae (Ia) and (Ib)

### Example 16

### Preparation of 2-[(1S,2R,3R,4S)-3-(diphenylphosphino)-1,7,7-trimethylbicyclo[2.2.1]hept-2-yl]pyridine

A flask was charged under argon with the compound from Example 12 (0.5 mmol, 208 mg), toluene (15 ml), trichlorosilane (10 equiv, 5 mmol, 0.5 ml) and triethylamine (20 equiv, 10 mmol, 1.4 ml), and the mixture was heated to 120° C. for 16 hours. After cooling to room temperature, toluene and the excess of trichlorosilane were removed under reduced pressure. The residue was taken up in toluene (15 ml) and admixed cautiously with degassed aqueous 10% NaHCO₃-solution. The phases were separated under argon, the toluene was removed and the residue was washed with diethyl ether. After filtration and drying under reduced pressure, the product was obtained as a viscous liquid (174 mg, 87%).

¹³C NMR (75 MHz, CDCl₃): δ 159.6, 147.0, 139.0 (d, J=15 Hz), 136.3 (d, J=15 Hz), 133.6, 133.4, 133.1, 131.5, 131.3, 128.0, 127.3-126.9 (m), 126.1 (d, J=7.6 Hz), 124.3, 123.6, 119.3, 55.6 (d, J=9.9 Hz), 50.4 (d, J=3.9 Hz), 50.0, 48.1 (d, J=12.5 Hz), 42.6 (d, J=13.7 Hz), 29.9 (d, J=7.3 Hz), 27.3, 20.0, 19.8 (d, J=20.0 Hz), 13.4 ppm.

³¹P NMR (81 MHz, CDCl₃): δ −2.1 ppm.

### Example 17

### Preparation of 2-[(1S,2R,3S,4S)-3-(diphenylphosphino)-1,7,7-trimethylbicyclo[2.2.1]hept-2-yl]-6-phenylpyridine

Analogously to Example 16, the aforementioned product was obtained starting from the compound from Example 11 in a yield of 92% of theory.

¹³C NMR (75 MHz, CDCl₃): δ 159.1, 153.7, 139.2 (d, J=15 Hz), 138.9, 136.2 (d, J=15 Hz), 134.5, 133.3 (d, J=18.8 Hz), 131.4 (d, J=18.8 Hz), 127.6-127.2 (m), 126.8, 126.1 (d, J=8.0 Hz) 125.6, 122.3, 115.7, 55.7 (d, J=9.9 Hz), 50.4 (d, J=4.1 Hz), 50.3, 48.1 (d, J=12.8 Hz), 42.4 (d, J=13.4 Hz), 30.1 (d, J=6.9 Hz), 27.4, 19.9, 19.7, 13.5 ppm.

³¹P NMR (81 MHz, CDCl₃): δ −2.05 ppm.

MS (EI, 70 ev): 475 (M⁺, 26), 392 (18), 290 (100), 182 (32).

### Example 18

### Preparation of 2-[(1S,2S,3R,4S)-3-(dicyclohexylphosphoryl)-1,7,7-trimethylbicyclo[2.2.1]hept-2-yl]pyridine

Analogously to Example 16, the aforementioned product was obtained starting from the compound from Example 12 in a yield of 61% of theory.

[α]²⁷_{D}=+14.7 (c 0.475, CHCl₃).

Mp: 128-132° C.

¹³C NMR (75 MHz, CDCl₃): δ 160.3, 148.9, 135.9, 126.1, 121.8, 53.3 (d, J=3.9 Hz), 51.7 (d, J=5.0 Hz), 50.6, 48.3 (d, J=2.1 Hz), 41.5-38.2 (m), 32.2 (d, J=11.8 Hz), 28.2-26.4 (m), 21.4, 20.1, 14.6 ppm.

³¹P NMR (81 MHz, CDCl₃): δ 50.8 ppm.

MS (EI, 70 ev): 427 (M⁺, 2.5), 344 (17), 214 (100).

### Example 19

### Preparation of 2-[(1S,2R,3S,4S)-3-(diphenylphosphino)-1,7,7-trimethylbicyclo[2.2.1]hept-2-yl]quinoline

Analogously to Example 16, the aforementioned product was obtained starting from the compound from Example 13 in a yield of 60% of theory.

¹³C NMR (75 MHz, CDCl₃): δ 160.1, 146.3, 139.2 (d, J=15.0 Hz), 136.1 (d, J=15.0 Hz), 133.5, 133.2, 133.1, 131.4 (d, J=17.2 Hz), 128.3, 127.4-126.8 (m), 126.0-125.4 (m), 124.2, 122.2, 56.4 (d, J=10.1 Hz), 50.9 (d, J=3.8 Hz), 50.5, 48.1 (d, J=12.8 Hz), 42.3 (d, J=13.7 Hz), 30.0 (d, J=7.4 Hz), 27.4, 20.0, 19.7, 13.7 ppm.

³¹P NMR (81 MHz, CDCl₃): δ −1.53 ppm.

MS (EI, 70 ev): 449 (M⁺, 28), 366 (17), 264 (100), 156 (33).

### Example 20

### Preparation of 2-[(1S,2R,3S,5R)-3-(diphenylphosphino)-6,6-dimethylbicyclo [3.1.1]hept-2-yl]pyridine

Analogously to Example 16, the aforementioned product was obtained starting from the compound from Example 14 in a yield of 81% of theory.

¹³C NMR (75 MHz, CDCl₃): δ 162.4 (d, J=2.6 Hz), 146.2, 136.8 (d, J=15.5 Hz), 136.2 (d, J=15.5 Hz), 134.1, 133.3 (d, J=18.7 Hz), 132.7 (d, J=18.7 Hz), 127.6-127.1 (m), 126.2 (d, J=7.0 Hz), 122.0, 119.1, 50.7 (d, J=2.6 Hz), 47.8 (d, J=4.9 Hz), 40.6 (d, J=2.3 Hz), 38.1 (d, J=1.6 Hz), 30.4 (d, J=17.8 Hz), 30.0, 26.5, 21.7, 21.4 (d, J=8.1 Hz) ppm.

³¹P NMR (81 MHz, CDCl₃): δ 10.5 ppm.

MS (EI, 70 ev): 385 (M⁺, 6), 308 (48), 200 (100).

### Example 21

### Preparation of 2-[(1S,2R,3S,5R)-3-(diphenylphosphino)-6,6-dimethylbicyclo [3.1.1]hept-2-yl]-6-phenylpyridine

Analogously to Example 16, the aforementioned product was obtained starting from the compound from Example 15 in a yield of 82% of theory.

¹³C NMR (75 MHz, CDCl₃): δ 161.9 (d, J=2.3 Hz), 153.0, 138.9, 136.9 (d, J=15.5 Hz), 136.1 (d, J=15.5 Hz), 135.0, 133.2 (d, J=18.8 Hz), 132.7 (d, J=18.8 Hz), 127.6-127.2 (m), 126.1 (d, J=7.4 Hz), 125.6, 120.5, 115.5, 50.7 (d, J=19.0 Hz), 47.7 (d, J=5.2 Hz), 40.7 (d, J=2.5 Hz), 38.4, 30.6 (d, J=18.5 Hz), 30.3, 26.6, 21.9, 21.4 (d, J=8.3 Hz) ppm.

³¹P NMR (81 MHz, CDCl₃): δ 10.1 ppm.

MS (EI, 70 ev): 461 (M⁺, 2), 384 (5), 276 (100).

### Examples 22-27

### Preparation of Iridium Complexes

### Example 22

### [Ir(16)(cod)]BARF

A two-necked flask with reflux condenser was charged with the ligand from Example 16 (0.1 mmol, 40 mg), [Ir(cod)Cl]₂ (0.05 mmol, 33.6 mg) and CH₂Cl₂ (5 ml). The solution was heated under reflux for one hour until the ³¹P NMR indicated the disappearance of the free ligand. After cooling to room temperature, Na[BARF] (0.15 mmol, 130 mg) and H₂O (5 ml) were added and the resulting biphasic reaction mixture was stirred vigorously for 30 min. The phases were separated, the aqueous phase was extracted with CH₂Cl₂ (2×20 ml), and the combined organic phases were washed with H₂O (10 ml) and concentrated under reduced pressure. The residue was purified by column chromatography with 50% CH₂Cl₂ in pentane as the eluent and gave rise to the iridium complex as an orange solid (88%, 138 mg).

Mp: 173-177° C.

¹³C NMR (75 MHz, CDCl₃): δ 163.5-161.1 (m), 151.7, 139.7, 135.2, 134.6 (d, J=12.6 Hz), 133.6 (d, J=9.3 Hz), 132.1-122.8 (m), 119.5, 117.8, 93.7 (d, J=8.8 Hz), 96.5 (d, J=14.6 Hz), 66.4, 63.6, 61.5 (d, J=7.4 Hz), 51.1, 49.0 (d, J=8.7 Hz), 46.8-45.8 (m), 37.4, 34.2-33.9 (m), 28.7, 28.2, 22.6, 20.6, 14.2 ppm.

³¹P NMR (81 MHz, CDCl₃): δ 18.9 ppm.

Elemental analysis (%) for C₆₇H₅₄BF₂₄IrNP: calc.: C, 51.48; H, 3.48; N, 0.90. found: C, 51.55; H, 3.39; N, 0.84.

### Example 23

### [Ir(17)(cod)]BARF

Analogously to Example 22, the aforementioned product was obtained starting from the ligand from Example 17 in a yield of 88% of theory.

Mp: 86-92° C.

¹³C NMR (75 MHz, CDCl₃): δ 163.3-159.7 (m), 137.9-121.1 (m), 116.5-116.4 (m), 80.0 (d, J=3.1 Hz), 75.7, 70.7 (d, J=23.7 Hz), 63.4, 55.5, 44.4 (d, J=5.3 Hz), 39.6 (d, J=27.3 Hz), 36.6, 34.5 (d, J=5.6 Hz), 31.5 (d, J=8.1 Hz), 27.1, 26.3, 22.0 (d, J=3.9 Hz), 19.8, 19.5, 13.9 Hz ppm.

³¹P NMR (81 MHz, CDCl₃): δ 19.9 ppm.

### Example 24

### [Ir(18)(cod)]BARF

Analogously to Example 21, the aforementioned product was obtained starting from the ligand from Example 18 in a yield of 75% of theory.

Mp: 154-160° C.

¹³C NMR (75 MHz, CDCl₃): δ 164.1-161.1 (m), 152.0, 139.7, 135.2, 130.3-128.6 (m), 126.7, 124.8, 123.0, 119.5, 117.8, 89.8 (d, J=8.1 Hz), 87.2 (d, J=14.5 Hz), 64.9, 61.7 (d, J=6.4 Hz), 59.1, 50.6, 48.4 (d, J=7.7 Hz), 47.9 (d, J=4.2 Hz), 41.7, 41.4, 40.5, 38.2, 36.4 (d, J=19.5 Hz), 33.4, 31.7-25.9 (m), 21.5, 20.5, 14.1 ppm.

³¹P NMR (81 MHz, CDCl₃): δ 14.3 ppm.

### Example 25

### [Ir(19)(cod)]BARF

Analogously to Example 21, the aforementioned product was obtained starting from the ligand from Example 19 in a yield of 88% of theory.

Mp: 165-169° C.

¹³C NMR (75 MHz, CDCl₃): δ 165.2-162.8 (m), 153.4, 141.4, 137.8 (d, J=53.1 Hz), 136.9, 136.4 (d, J=12.5 Hz), 135.3 (d, J=9.4 Hz), 133.9-133.6 (m), 132.1-130.3 (m), 128.5, 126.6, 125.2-124.6 (m), 119.6-119.5 (m), 95.6 (d, J=8.7 Hz), 94.3 (d, J=15.0 Hz), 68.2, 65.3, 63.3 (d, J=7.5 Hz), 52.8, 50.7 (d, J=8.5 Hz), 48.6 (d, J=3.8 Hz), 47.7 (d, J=26.3 Hz), 39.1 (d, J=3.6 Hz), 36.3-35.6 (m), 30.5, 29.9, 28.9, 28.5, 24.3, 22.4, 14.2 ppm.

³¹P NMR (81 MHz, CDCl₃): δ 18.9 ppm.

### Example 26

### [Ir(20)(cod)]BARF

Analogously to Example 21, the aforementioned product was obtained starting from the ligand from Example 20 in a yield of 85% of theory.

Mp: 85-90° C.

¹H NMR (200 MHz, CDCl₃): δ 8.62-8.54 (m, 1H), 7.80-7.00 (m, 25H), 4.86-4.62 (m, 1H), 4.56-4.42 (m, 1H), 4.36-4.20 (m, 1H), 3.90-3.78 (m, 1H), 3.10-2.90 (m, 1H), 2.80-1.00 (m, 18H), 0.85 (s, 3H) ppm.

³¹P NMR (81 MHz, CDCl₃): δ 11.7 ppm.

### Example 27

### [Ir(16)(cod)]PF₆

Analogously to Example 22, the aforementioned product was obtained starting from the ligand from Example 16, except using ammonium hexafluorophosphate, in a yield of 80% of theory.

Mp: 217-220° C.

³¹P NMR (81 MHz, CDCl₃): δ 19.5, −143.1 (quint, J=713 Hz) ppm.

Enantioselective Hydrogenation of Olefins and Imines

### Examples 28-48

Hydrogenation of:

E-1,2-diphenylpropene (S1)
(E)-2-(4-methoxyphenyl)-1-phenylpropene (S2),
ethyl 3-phenyl-2-butenoate (S3),
3-phenyl-2-methylallyl alcohol (S4),
3-phenyl-2-methylallyl acetate (S5),
N-acetylphenylalanine methyl ester (S6) and
N-phenylbenzophenonimine (S7)

The particular complex, the substrate (0.4 mmol) and toluene (2 ml) were introduced into an autoclave. The autoclave was sealed and charged with hydrogen pressure, and the reaction mixture was stirred for a certain time. The toluene was removed and the crude product was flushed through a short silica gel column with pentane as the eluent. After removal of the solvent, the product was obtained. The results are shown in Table 1.

TABLE 1
Iridium-catalysed enantioselective hydrogenations:

| | Complex | | | Reaction | | |
|---|---|---|---|---|---|---|
| | from | | | conditions | % | |
| Example | Example | Mol % | Substrate | (bar, h, T) | Conversion | % ee |
| 27 | 22 | 1 | S1 | (50, 12, 25° C.) | 44 | 93.5 (S) |
| 28 | 22 | 1 | S1 | (50, 12, 25° C.) | 100 | 95 (S) |
| 29 | 22 | 0.5 | S1 | (50, 12, 25° C.) | 100 | 95 (S) |
| 30 | 22 | 1 | S1 | (1, 5, 25° C.) | 91 | 95 (S) |
| 31 | 22 | 0.5 | S1 | (1, 2, 25° C.) | 90 | 95 (S) |
| 32 | 24 | 1 | S1 | (1, 12, 25° C.) | 80 | 80 (S) |
| 33 | 25 | 1 | S1 | (50, 12, 25° C.) | 100 | 95 (S) |
| 34 | 25 | 1 | S1 | (50, 12, 25° C.) | 100 | 94 (S) |
| 35 | 25 | 1 | S1 | (50, 2, 25° C.) | 100 | 95 (S) |
| 36 | 25 | 0.5 | S1 | (1, 5, 25° C.) | 96 | 96 (S) |
| 37 | 25 | 0.1 | S1 | (50, 12, 25° C.) | 92 | 95 (S) |
| 38 | 26 | 1 | S1 | (50, 2, 25° C.) | 26 | 80 (R) |
| 39 | 22 | 1 | S2 | (50, 2, 25° C.) | 87 | 91 (S) |
| 40 | 25 | 1 | S2 | (50, 2, 25° C.) | 100 | 94.7 (S) |
| 41 | 25 | 1 | S2 | (1, 2, 25° C.) | 76 | 94 (S) |
| 42 | 25 | 1 | S2 | (50, 2, 25° C.) | 75 | 95.2 (S) |
| 43 | 22 | 1 | S3 | (50, 2, 25° C.) | 65 | 58 (S) |
| 44 | 22 | 1 | S4 | (50, 2, 25° C.) | 94 | 69 (S) |
| 45 | 22 | 1 | S5 | (50, 2, 25° C.) | 100 | 80 (S) |
| 46* | 22 | 1 | S6 | (50, 2, 25° C.) | 100 | 95.4 (S) |
| 47* | 22 | 1 | S6 | (50, 2, 50° C.) | 100 | 96.5 (S) |
| 48*,** | 25 | 1 | S7 | (80, 16, 40° C.) | 100 | 21 (S) |

*Solvent CH₂Cl₂,
**Addition of 1 mol % of iodine

### Examples 49 and 50

### Palladium-catalysed allylic amination of 1,3-diphenylallyl acetate

### Example 49

### Preparation of (−)-(R,E)-N-benzyl-(1,3-diphenyl-2-propenyl)amine

Allylpalladium chloride dimer (4.0 μmol, 1.5 mg, 1.0 mol %) and the ligand from Example 20 (8.0 μmol, 3.1 mg, 2.0 mol %) were dissolved in toluene (1 ml) and stirred at room temperature for 10 min. A solution of 3-acetoxy-1,3-diphenylpropene (0.4 mmol, 100 mg) in toluene (3 ml) was added and the mixture was stirred for a further 15 min. Subsequently, benzylamine (0.8 mmol, 86 mg) was added and the mixture was stirred at room temperature for a further 12 h. The mixture was quenched with saturated aqueous NH₄Cl solution and extracted with diethyl ether. The organic phase was washed with H₂O (10 ml) and concentrated under reduced pressure. The residue was purified by column chromatography with 50% diethyl ether in pentane as the eluent and gave rise to the desired product (95%, 114 mg) with an enantiomeric purity of 87% ee as a pale yellow oil.

### Example 50

### Preparation of trans-(R)-methyl 2-carbomethoxy-3,5-diphenylpent-4-enolate

Allylpalladium chloride dimer (12.5 μmol, 4.6 mg, 2.5 mol %), potassium acetate (25 μmol, 3.5 mg, 5.0 mol %) and the ligand from Example 16 (25 μmol, 10 mg, 5.0 mol %) were dissolved in CH₂Cl₂ (1 ml) and stirred at room temperature for 10 min. A solution of 3-acetoxy-1,3-diphenylpropene (0.5 mmol, 126 mg) in CH₂Cl₂ (2 ml) and N,O-bistrimethylsilylacetamide (1.5 mmol, 0.4 ml) was added and the mixture was stirred for a further 15 min. Subsequently, benzylamine (0.8 mmol, 86 mg) was added and the mixture was stirred at room temperature for a further 12 h. The mixture was quenched with saturated aqueous NH₄Cl solution and extracted with diethyl ether. The organic phase was washed with H₂O (10 ml) and concentrated under reduced pressure. The residue was purified by column chromatography with 25% ethyl acetate in pentane as the eluent and gave rise to the desired product (75%, 122 mg) with an enantiomeric purity of 96% ee as a pale yellow oil.

### Examples 51-53

### Iridium-Catalysed Asymmetric Hydroboration

### Preparation of (N,N-dibenzylcarbonyloxy)-4,5-diazanorbornan-1-ol

[Ir(cod)Cl]₂ (3.4 mg, 0.005 mmol), ligand (0.011 mmol) and (N,N-dibenzylcarbonyloxy)-4,5-diazanorbornene (0.18 g, 0.5 mmol) was introduced into a Schlenk flask under argon together with degassed THF (0.85 ml) at −50° C. The reaction mixture was stirred at room temperature for 30 min and then cooled to 0° C. Catecholborane (0.11 ml, 1 mmol) was added and the mixture was stirred for a further 4 hours. EtOH (0.5 ml), 3M aqueous NaOH (0.85 ml) and 30% H₂O₂ (0.5 ml) were added and the resulting mixture was stirred overnight. After extraction with ethyl acetate (3×10 ml), the combined organic phases were washed with 1M aqueous NaOH (5×10 ml) and saturated sodium chloride solution and subsequently concentrated. The residue was purified by column chromatography with 50% ethyl acetate in cyclohexane as the eluent and gave rise to the desired enantiomerically enriched alcohol. The results for different ligands are reported in Table 2.

TABLE 2
Iridium-catalysed hydrogenation
of (N,N-dibenzylcarbonyloxy)-4,5-diazanorbornene

| | Ligand from | | | % | |
|---|---|---|---|---|---|
| Example | Example | % ee | % Yield | Conversion | Configuration |
| 51 | 16 | 71 | 57 | 95 | (1S, 4S, 5S) |
| 52 | 19 | 13 | 43 | 85 | (1S, 4S, 5S) |
| 53 | 20 | 44 | 67 | 95 | (1S, 4S, 5S) |

1. Compounds of the formula (I) 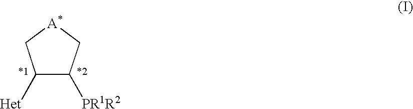
in which
*1, *2 each independently mark a stereogenic carbon atom which is in R or S configuration,
R¹ and R² are each independently an optionally substituted hydrocarbon radical having a total of 1 to 18 carbon atoms
Het is optionally substituted azoaryl and
A* is a carbodivalent, cyclic and optionally substituted radical which has a total of 5 to 18 carbon atoms and in itself, as a symmetry element, does not possess any mirror plane.

2. Compounds according to claim 1, characterized in that they are stereoisomerically enriched.

3. Compounds according to claim 2, characterized in that the relative proportion of only one stereoisomer based on the sum of all stereoisomers is at least 98.5%.

4. Compounds according to at least one of claims 1 to 3, characterized in that R¹ and R² are each independently C₁-C₂₀-alkyl, C₁-C₂₀-fluoroalkyl, C₂-C₂₀-alkenyl, C₄-C₂₄-aryl, C₅-C₂₅-arylalkyl or C₆-C₂₆-arylalkenyl, or together are a cyclic radical having a total of 4 to 20 carbon atoms.

5. Compounds according to at least one of claims 1 to 4, characterized in that they are the following:
2-[(1S,2R,3R,4s)-3-(diphenylphosphino)-1,7,7-trimethylbicyclo[2.2.1]hept-2-yl]pyridine,
2-[(1S,2R,3S,4S)-3-(diphenylphosphino)-1,7,7-trimethylbicyclo[2.2.1]-hept-2-yl]-6-phenylpyridine,
2-[(1S,2R,3S,4S)-3-(diphenylphosphino)-1,7,7-trimethylbicyclo-[2.2.1]-hept-2-yl]quinoline,
2-[(1S,2R,3R,4S)-3-(dicyclohexylphosphino)-1,7,7-trimethylbicyclo[2.2.1]-hept-2-yl]pyridine,
2-[(1S,2R,3S,5R)-3-(diphenylphosphino)-6,6-dimethylbicyclo[3.1.1]hept-2-yl]pyridine and
2-[(1S,2R,3S,5R)-3-(diphenylphosphino)-6,6-dimethylbicyclo[3.1.1]hept-2-yl]-6-phenylpyridine.

6. Compounds of the formula (IV) (IV), 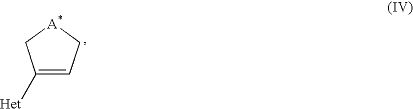
in which
Het and A* are each as defined in claim 1.

8. Compounds according to claim 7, characterized in that they are the following:
2-[(1S,2S,3R,4S)-3-(diphenylphosphoryl)-1,7,7-trimethylbicyclo[2.2.1]hept-2-yl]pyridine,
2-[(1S,2R,3S,4S)-3-(diphenylphosphoryl)-1,7,7-trimethylbicyclo[2.2.1]hept-2-yl]-6-phenylpyridine,
2-[(1S,2S,3R,4S)-3-(dicyclohexylphosphoryl)-1,7,7-trimethylbicyclo[2.2.1]hept-2-yl]pyridine,
2-[(1S,2S,3R,4S)-3-(diphenylphosphoryl)-1,7,7-trimethylbicyclo[2.2.1]hept-2-yl]quinoline,
2-[(1S,2R,3S,5R)-3-(diphenylphosphoryl)-6,6-dimethylbicyclo[3.1.1]hept-2-yl]pyridine
2-[(1S,2R,3S,5R)-3-(diphenylphosphoryl)-6,6-dimethylbicyclo[3.1.1]hept-2-yl]-6-phenylpyridine.

9. Compounds of the formula (VII) 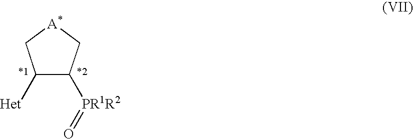
in which
1*, 2*, Het, A*, R¹ and R² are each as defined in claim 1.

10. Compounds according to claim 9, characterized in that they are the following:
2-[(1S,2S,3R,4S)-3-(diphenylphosphoryl)-1,7,7-trimethylbicyclo[2.2.1]hept-2-yl]pyridine,
2-[(1S,2R,3S,4S)-3-(diphenylphosphoryl)-1,7,7-trimethylbicyclo[2.2.1]hept-2-yl]-6-phenylpyridine,
2-[(1S,2S,3R,4s)-3-(dicyclohexylphosphoryl)-1,7,7-trimethylbicyclo[2.2.1]hept-2-yl]pyridine,
2-[(1S,2S,3R,4s)-3-(diphenylphosphoryl)-1,7,7-trimethylbicyclo[2.2.1]hept-2-yl]quinoline,
2-[(1S,2R,3S,5R)-3-(diphenylphosphoryl)-6,6-dimethylbicyclo[3.1.1]hept-2-yl]pyridine and
2-[(1S,2R,3S,5R)-3-(diphenylphosphoryl)-6,6-dimethylbicyclo[3.1.1]hept-2-yl]-6-phenylpyridine.

11. Transition metal complexes comprising compounds according to one or more of claims 1 to 6.

12. Transition metal complexes according to claim 11, characterized in that transition metal complexes are complexes of ruthenium, osmium, cobalt, rhodium, iridium, nickel, palladium, platinum and copper.

13. Catalysts comprising transition metal complexes according to at least one of claims 11 and 12.

14. Use of catalysts according to claim 13 for 1,4 additions, allylic substitutions, hydroborations, hydroformylations, hydrocyanations, Heck reactions and hydrogenations.

15. Process for preparing stereoisomerically enriched compounds, characterized in that the stereoisomerically enriched compounds are obtained either by catalytic hydrogenation of olefins, enamines, enamides, imines or ketones, or by hydroboration of alkenes and, if appropriate, subsequent oxidation, or by allylic substitution, and the catalysts used are those according to claim 13.

16. Process for preparing stereoisomerically enriched active ingredients of medicaments and agrochemicals, or intermediates of these two classes, characterized in that the catalysts used are those according to claim 13.
